(19) United States
(12) Patent Application Publication
(10) Pub. No.: US 2021/0320437 A1
(43) Pub. Date: Oct. 14, 2021

(54) CONNECTION DEVICE FOR THE CONNECTION OF A CONDUCTOR END

(71) Applicant: Weidmüller Interface GmbH & Co. KG, Detmold (DE)

(72) Inventors: Karlo STJEPANOVIC, Bielefeld (DE); Stephan FEHLING, Detmold (DE); Stefan FISCHER, Detmold (DE); Frank HACKEMACK, Detmold (DE); Andreas RUTZ, Bielefeld (DE)

(21) Appl. No.: 16/767,038

(22) PCT Filed: Nov. 21, 2018
(86) PCT No.: PCT/EP2018/082078

§ 371 Date: Oct. 27, 2020

(30) Foreign Application Priority Data
Nov. 28, 2017 (DE) 20 2017 107 202.9

(51) Int. Cl. H01R 4/48; H01R 11/09

(52) U.S. Cl. CPC H01R 4/4836; H01R 11/09

(57) ABSTRACT

A connection device for the connection of a conductor end includes a housing having a slotted link, a busbar section having a slotted link aligned with the housing slotted link, an d clamping spring assembly rotatably connected with the housing and operable between an open position and a contact position with the conductor end. A rotary lever assembly including a rotary lever element is operably connected with the clamping spring assembly. The rotary lever element has a cam section and a control curve section on which the clamping spring assembly slides during movement into the contact position. A clamping device is arranged on the cam section and is retained by the housing and busbar slotted links.

The invention relates to a connection device for the connection of a conductor end in accordance with the preamble of claim 1.

Connection devices of this type are known in the art. However, with regard to the handling and structural design of the known connection devices, they are only able to be actuated with difficulty, specifically when contacting conductors of larger diameter, and therefore require improvement.

Against this background, the object of the invention is to provide a connection device which is improved in terms of the handling and structural design thereof.

The invention achieves this object by way of the subject matter of claim 1.

The invention provides a connection device for the connection of a conductor end, which connection device has a housing and also a busbar section, a clamping spring arrangement and a rotary lever arrangement in the housing, the clamping spring arrangement being able to be rotated, with the aid of the rotary lever arrangement, from an open position to a contact position in which contact is made with the conductor end. Thereby, the rotary lever arrangement and the clamping spring arrangement—always or at least during the rotation from the open position into the contact position—have the same direction of rotation.

It is particularly advantageous that, as a result of the identical directions of rotation, the effective lever arm, by means of which the rotary lever arrangement acts on the clamping spring arrangement, becomes larger and larger during the movement from the opening position into the contact position. This is particularly advantageous because the force onto the clamping spring arrangement can become larger before the end contact position is reached, so that a very high force acts on the conductor end both before an end contact position is reached and in an end contact position, this force leading to or resulting in a high contact force before an end contact position is reached and in the end contact position which is to be reached. The actuating forces can nevertheless be kept relatively favourable—in particular relatively low.

To achieve larger contact forces and a compact, narrow design, it may advantageously be provided that the axis of rotation D1 of the clamping spring arrangement and sections of the clamping spring arrangement are arranged above the conductor end to be contacted and above the associated busbar section, and that the rotary lever arrangement has an axis of rotation D2 which is positioned above the axis of rotation D1 of the clamping spring arrangement.

In a further preferred variant, the busbar section may be configured trough-shaped, in particular V- or U-shaped, in cross section, the conductor end being insertable into the busbar section perpendicular to this cross section, and the clamping spring arrangement being designed to be pivoted, at least in sections, into the busbar section transverse to the conductor insertion direction so as to press the conductor end in the end contact position into the trough-shaped busbar section so as to contact said section. The invention is particularly well-suited to a structural configuration of this type.

It may further advantageously be provided that the rotary lever arrangement has a rotary lever element which is mounted rotatably in the housing in or on a preferably central section and has the axis of rotation, and that the rotary lever element preferably has a cam section, which has—preferably on the face thereof facing the clamping spring arrangement—a control curve on which the actuating limb or limbs of the clamping springs slide along during a movement into the end contact position. Amongst the advantages of the identical directions of rotation is that the effective lever can be well adapted to any angle of rotation and thus be optimally adapted to the force requirements. By preselecting the relevant dimensions, it is thus possible to implement a desired lever ratio in a simple manner, for example in order to achieve a low actuating force.

To ensure a well-guided movement into and out of the end contact position and to ensure a flow of force over metal parts, it may be provided that a projection of the cam section or a pin or the like inserted into said section engages in a slotted link of the housing, specifically in an arc-shaped slotted link.

To secure the end contact position, it may be provided that, in the end contact position, the clamping spring arrangement and/or the actuating limb are additionally fixed, by means of a locking device, in a positive and/or non-positive fit, for example on the busbar section or on another element.

For this purpose, a clamping and/or latching means, for example the aforementioned pin which is movable into a fixing position in the slotted link, may be formed on the cam section, it being advantageous for the fixing position to be formed in the—preferably metal—busbar section, since in this way a high contact force can also be durably ensured.

It may further advantageously be provided that the actuating limb or limbs are formed elbowed at the free ends thereof so as to slide on the control curve.

The clamping spring arrangement may have a spring carrier. The spring carrier may be formed in a single piece with the housing. However, the spring carrier may also—if an actuating limb is arranged rotationally engaged thereon—join in with the functionality of this actuating limb in whole or in part. In this case, said carrier forms part of the clamping spring arrangement within the meaning of the claims.

Advantageous embodiments of the invention may be derived from the dependent claims.

In the following, the invention is described in greater detail by way of embodiments with reference to the drawings, with further advantageous variants and configurations also being discussed. It should be emphasised that the embodiment discussed in the following is not intended to describe the invention conclusively, and that variants and equivalents which are not shown also fall within the claims. In the drawings:

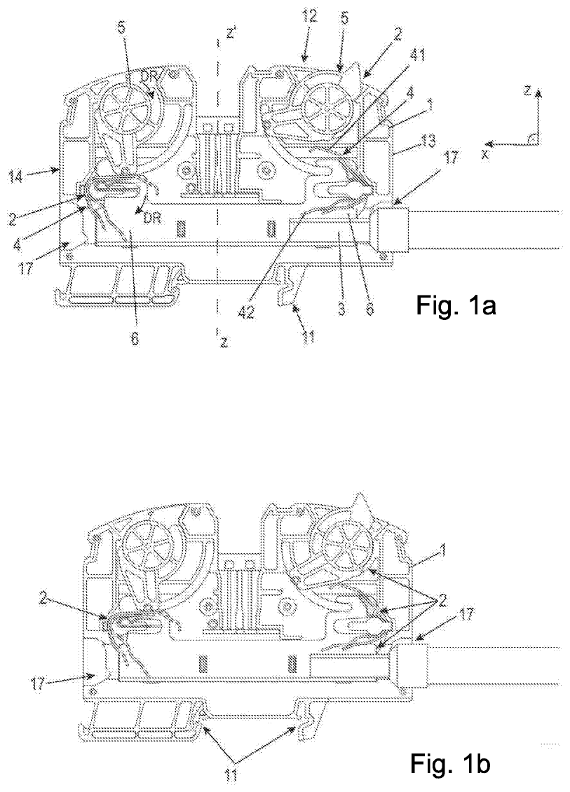

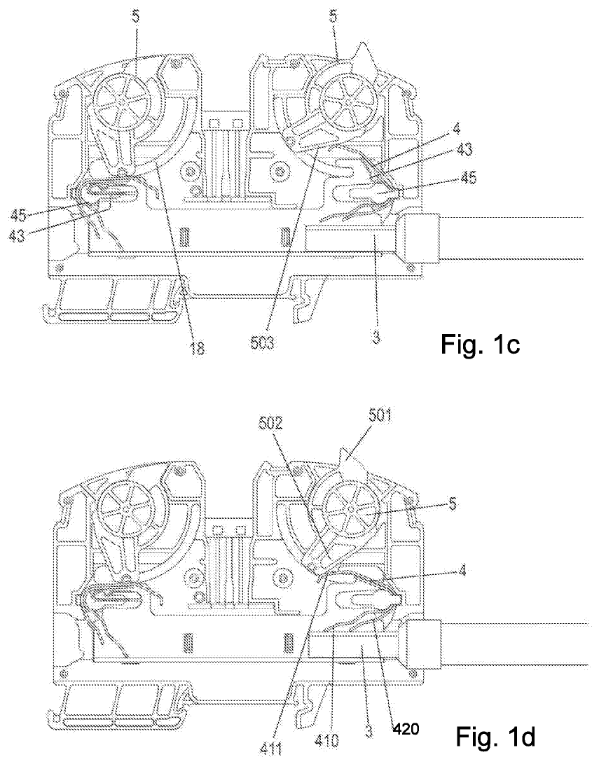

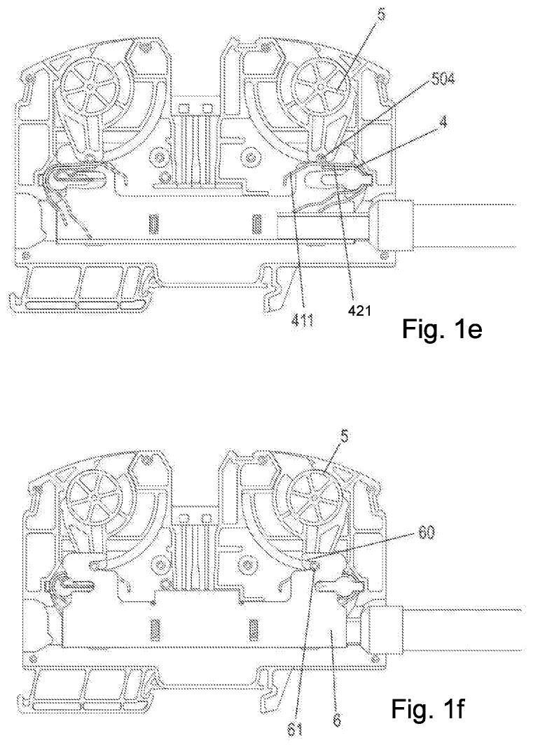

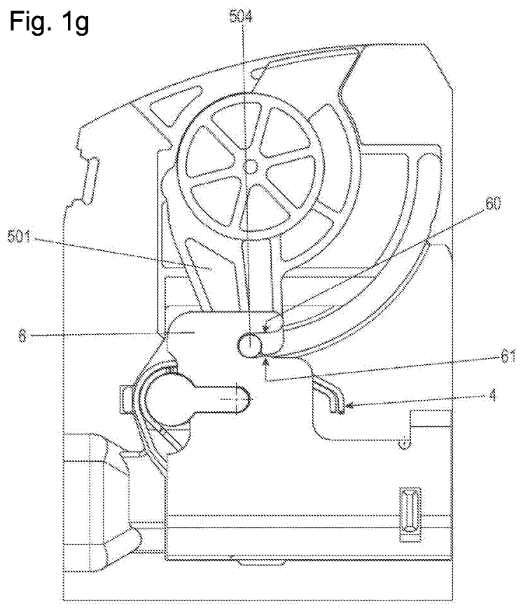

FIG. 1 a) shows a sectional view of a series terminal comprising connection devices according to the invention, of which one is in a first, closed operating position, without a conductor end inserted into it, and of which the other, second connection device is in an open, first operating position upon insertion of the conductor end; b) to e) show the series terminal of FIG. 1, the second connection device in each case being or having been moved, in temporally successive steps, into a contact position which is reached in FIG. 1 e); and f) shows a side view of the series terminal in the operating position of e), without a side wall that is optionally further attached/formed on the side;

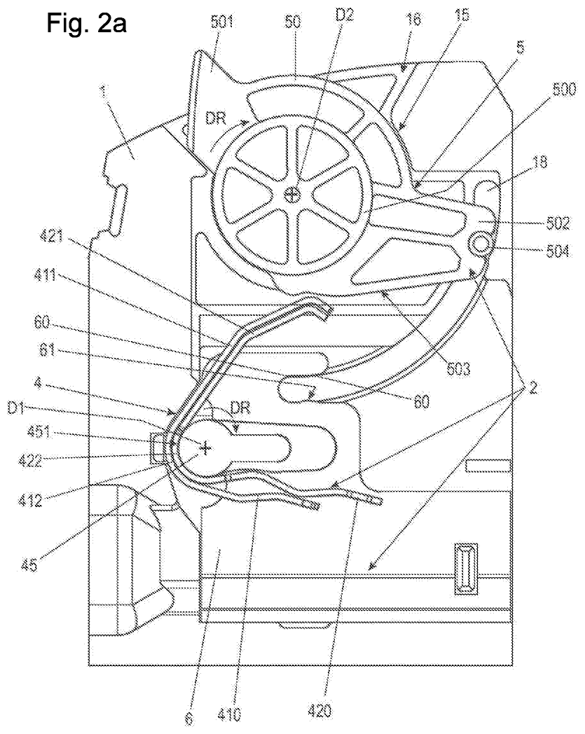

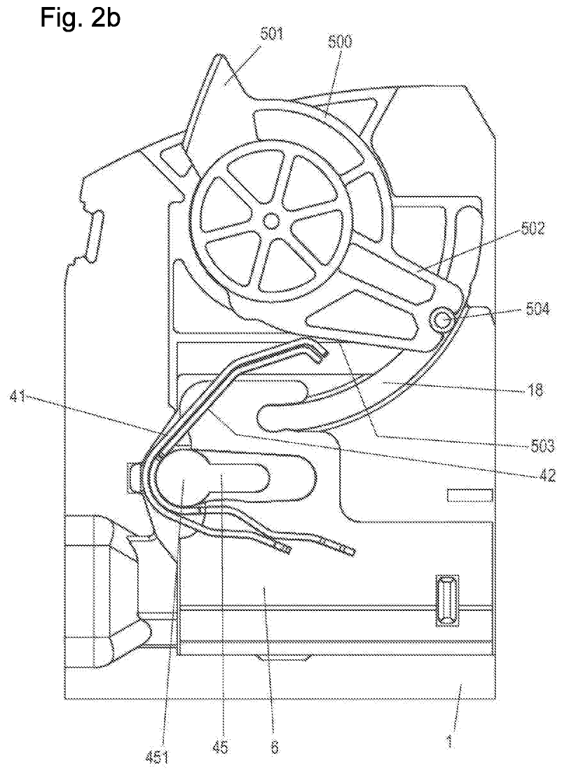

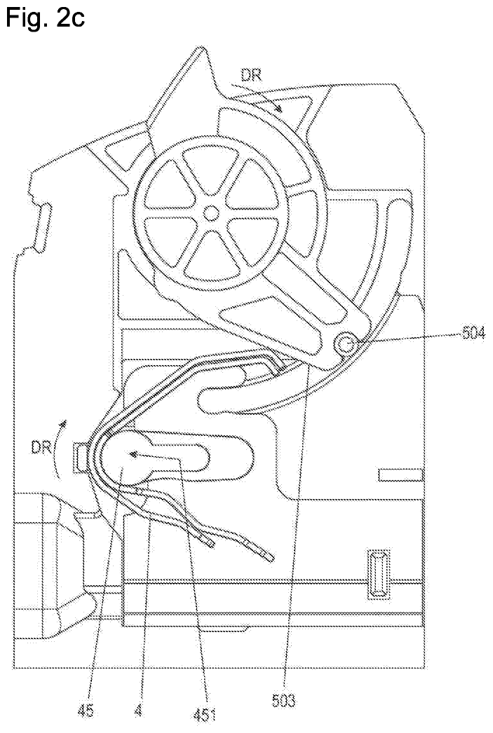

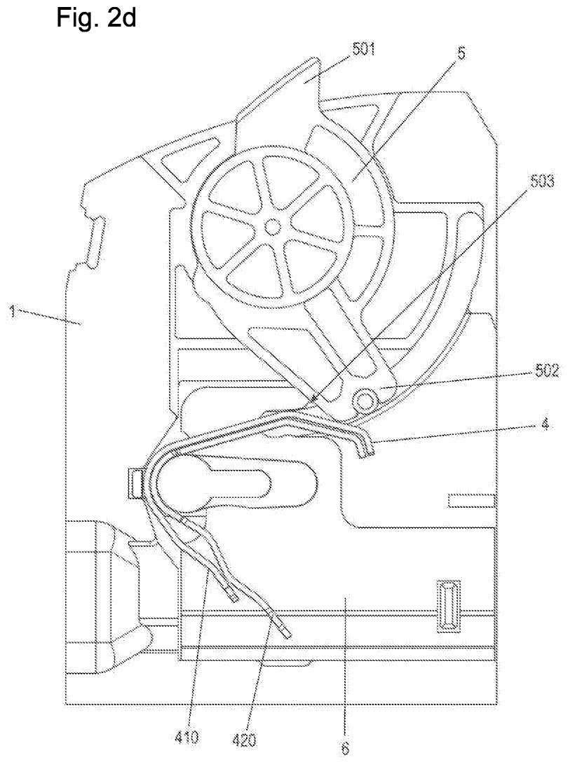

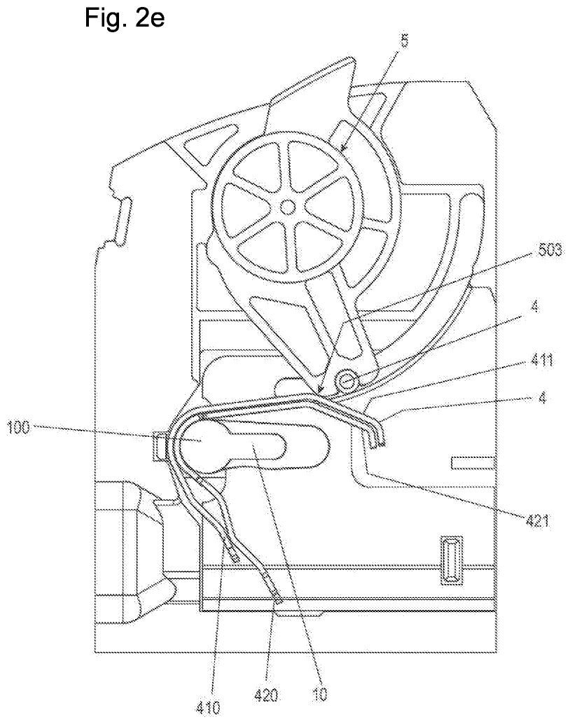

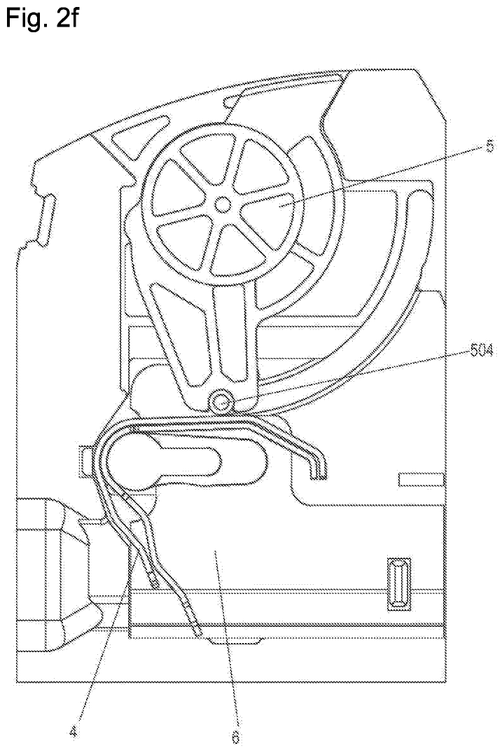

FIG. 2 a) to f) show a detail of the view of FIG. 1 a) with the first connection device in various operating positions, in which it is moved from an open position into a contact position—without a conductor—from a) to e);

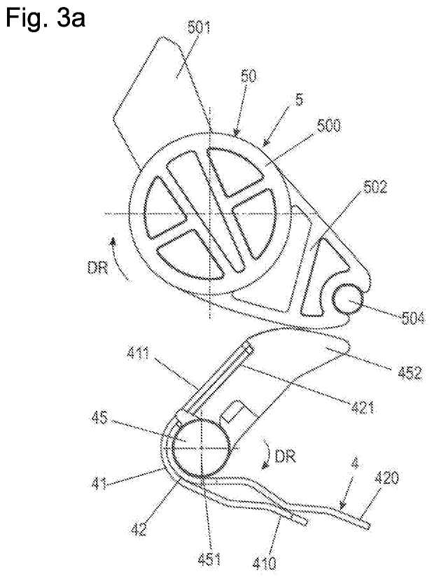

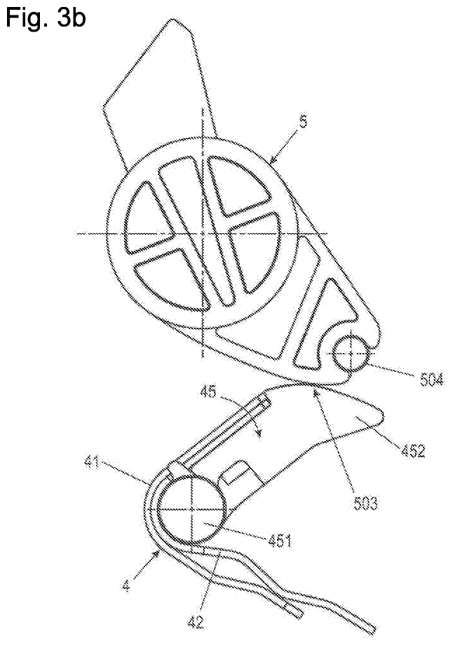

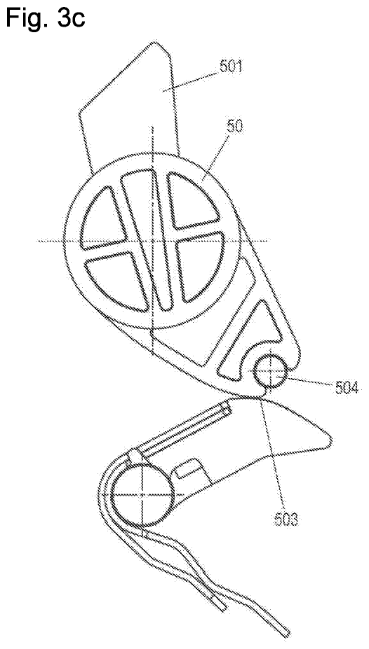

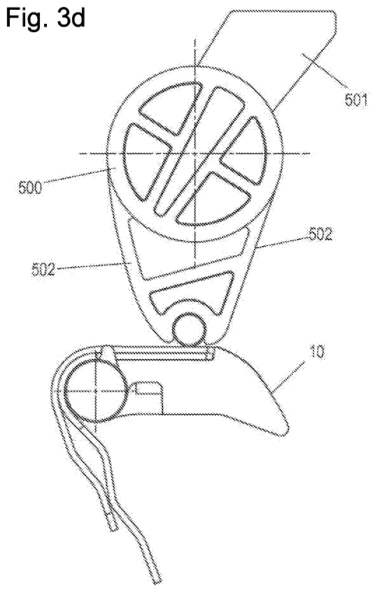

FIG. 3 a) to d) show movable elements of a variant of the connection device of FIG. 2 in various operating positions, in which the connection device is moved from an open position into a contact position—without a conductor—from a) to d); and

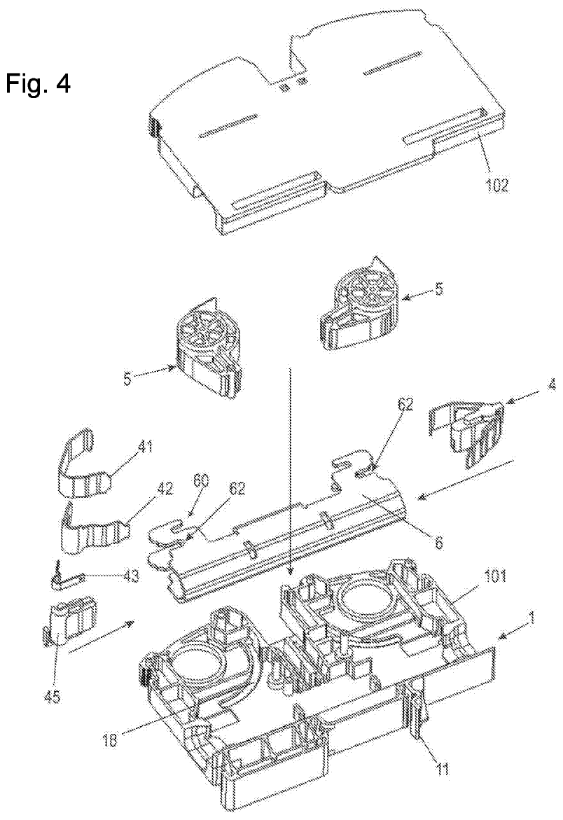

FIG. 4 shows an exploded view of a series terminal in the manner of FIG. 1;

For simplicity, a Cartesian coordinate system X/Z is illustrated in FIG. 1, the direction perpendicular to the plane of the page being designated as the Y-direction. In the following, the conductor insertion direction is designated as the X-direction.

FIG. 1 shows a housing 1, which in this case is formed as a terminal housing. One or more—in this case two—connection devices 2 for connecting an associated conductor end 3 are arranged in the housing. In FIG. 1, only one of these conductor ends 3 is shown. The conductor ends 3 may be (preferably insulation-stripped) single wires or multiple or stranded conductors or for example crimped wire ends of a highly electrically conductive material, such as copper.

The housing 1 consists of electrically insulating material, in particular of a non-conductive plastics material. The housing 1 is formed disc-shaped in this case, and is preferably configured to be stackable in the Y-direction perpendicular to the conductor insertion direction. The terms right, left, up and down are based on the portrayal in the drawings, and accordingly change when the housing 1 moves in space.

The housing 1 may have an affixing foot 11. In this case, said foot is formed for placement, in particular latching, on a carrier rail (not shown, for example hat-shaped in cross section). The housing 1 further has an upper face 12 (this being the face remote from the affixing foot 11) and two plug-in faces 13, 14. In an (imaginary) coordinate system, the direction perpendicular to the plane of the drawing is designated as the Y-direction (the carrier rail extending in this direction), the direction perpendicular to the carrier rail (in FIG. 1 the vertically upward direction) as the Z-direction, and the direction perpendicular thereto (leftwards in FIG. 1) as the X-direction. The two conductor ends 3 are movable in and counter to the X-direction. Thus, the conductor insertion direction of the right conductor end 3 into the right connection device 2 is the X-direction and the conductor insertion direction of the left conductor end (not shown here) into the left connection device 2 is the −X-direction.

The connection devices 2 may be formed identically or be symmetrical with respect to one another, in other words mirror-symmetrical about the imaginary plane z-z perpendicular to the plane of the drawing. As a result, two conductor ends 3 can be inserted into the housing 1, well and in a simple manner, from opposite sides and can be contacted therein by the associated connection device 2. This has for example advantageously been implemented in the embodiment of FIG. 1-3. One, two as shown, or even more of the connection devices may be arranged in a housing, and thus side by side (for example in a multi-part housing 1).

The connection devices 2 each have a clamping spring arrangement 4 and a rotary lever arrangement 5. In addition, they each have a busbar section 6 against which the associated conductor end can be pressed or pushed by means of the clamping spring arrangement. The clamping spring arrangement 4 acts in the manner of a compression spring in each case.

In FIG. 1, the busbar sections 6 are configured in a single piece with one another, in such a way that the two connection devices 2 are conductively connected by an in this case singlepiece busbar. In this way, a through-terminal is implemented between the two connection devices without an electrical functional module. It would also be conceivable to form the two busbar sections 6 as separate busbars which are conductively interconnected directly or via at least one electrical or electronic component.

The busbar sections 6 preferably have a V or U shape in cross section (see also FIG. 1f). The primary extension direction of the busbar sections 6 is the X-direction perpendicular to this V or U cross section. The associated conductor end 3 is inserted into the connection devices 2 parallel to this primary extension direction (+X, −X) in each case. For this purpose, in the extension of the associated busbar section 6, each housing 1 has an insertion opening 17 for the conductor. The V or U shape may extend over the entire length of the busbar arrangement in the primary extension direction or else over part of the length.

The clamping spring arrangement 4 is embodied in such a way that, for introducing the associated conductor end 3, it is pivotable out of the busbar section 6 in such a way that a conductor end 3 is insertable into the associated busbar section 6 through the insertion opening 17. To contact the conductor, the clamping spring arrangement 4 as a whole is pivoted towards and partially into the busbar section 6, with the conductor end 3 being contacted. The clamping spring arrangement 4 finally takes on a fixed position in the contact position and presses the conductor end 3 against the associated busbar section 6 made of electrically highly conductive material, in such a way that at least one contact point through which an electric current can flow is formed.

The clamping spring arrangement 4 consists of one or more clamping springs 41, 42 (for which see also FIGS. 2a and 3a), which are embodied as leaf springs. In FIG. 1, two leaf springs are provided, and serve to generate a sufficient contact force. These leaf springs each have at least one clamping limb 410, 420 and at least one actuating limb 411, 421. The at least one clamping limb 410, 420 and the at least one actuating limb 411, 421 are angled, preferably acute-angled at an angle of between 5° and 85° to one another. They are further preferably each interconnected via a bending region 412, 422 or a sort of radius. The bending region 412, 422 is preferably positioned on a spring carrier 45. In FIGS. 2 and 3, the conductor end is not shown in each case, so as better to illustrate the rotational movement of the clamping spring arrangement 4, which otherwise is influenced by the action of the clamping limb 3 on the conductor end 3. In addition, there is a further leaf spring 43, which is a restoring spring. It is preferably also preassembled on the spring carrier 45, is supported on this and the clamping springs and can be biased upon movement into the contact position, in order to return the clamping springs 41, 42 upon release of the clamping position.

The spring carrier 45 may be formed in a single piece with the housing 1 or as a separate part from the housing. If it is formed separately from the housing 1, it is advantageous for the clamping spring arrangement 4 to be capable of being preassembled on the spring carrier 45, and for the preassembled unit subsequently to be insertable into the housing separately and fixable therein, for example in a positive and/or non-positive fit, in particular by clamping and/or latching. The spring carrier 45 may also be arranged pivotably in the housing. In this case, it may even—if the actuating limb is arranged rotationally engaged thereon—join in with the functionality of this actuating limb 410 in whole or in part. This functionality is shown in FIG. 3. In this case, said carrier forms part of the clamping spring arrangement 4 within the meaning of the claims. The spring carrier 45 may also be able to be preassembled on the busbar, preferably in each case in slots 62 of the busbar sections 6.

The clamping springs 41, 42 of the leaf spring arrangement are preferably arranged laid inside one another in a stack-like manner. This means that the bending regions 412, 422 thereof are positioned inside one another and have exactly or substantially the same axis of rotation D1 or D1′. In this case, the support contour has a rounded journal section 451, about which the clamping springs 41, 42 can be rotated in the bending regions 411, 412 thereof. In this case the spring carrier 45 serves, in the manner of a bolt, in the region in which the bending region 412, 422 is positioned against it, as a pivot bearing for the clamping spring arrangement or for the one or more individual springs or clamping springs of the clamping spring arrangement 4.

Preferable, the actuating limbs 411, 421 and/or the clamping limbs 410, 420 of the leaf springs 41, 42 are of different lengths. If the actuating limbs 411, 421 are of different lengths, this makes it possible to contact conductor ends 3 of different diameter very well, at positions respectively well-suited thereto, in a simple manner. It is also conceivable to contact a single conductor end 3 using two or more leaf springs at different points.

The clamping spring arrangement 4 is preferably orientated in such a way that the bending region 412, 422 is closest to the associated conductor insertion opening 17, in such a way that the clamping limb 410, 420, proceeding from the bending region 412, 422, extends away from the conductor insertion opening 17. The associated clamping limb 410, 420 and the associated actuating limb 411, 421 are thus preferably positioned at an acute angle to the conductor insertion direction (X-direction).

The axes of rotation D1 of the clamping spring arrangement(s) 4 and sections of the clamping spring arrangement 4 are positioned in the region of the support contour, or the support contour is positioned above the conductor end 3 to be contacted and above the associated busbar section 6 in the Z-direction—in other words in this case perpendicular to the affixing foot or to the carrier rail. The associated rotary lever arrangement 5, which has an axis of rotation D2, is further arranged above the clamping spring arrangement 4 in the Z-direction. The axis of rotation D2 is positioned above the axis of rotation D1 of the clamping spring arrangement in the Z-direction.

Overall, an arrangement is produced in such a way that in the housing 1, for each connection device 2, the busbar arrangement 6 is arranged below and the open face of the V- or U-shaped cross section thereof is directed towards the associated clamping spring arrangement 4, in such a way that the clamping limb or limbs 410, 420 are pivotable into the busbar arrangement. In addition, the axis of rotation D2 of the rotary lever arrangement 5 is formed and arranged above the clamping spring arrangement 4. In this context, the directions of rotation DR of the rotary lever arrangement 5 and DR of the clamping spring arrangement 4 are in the same direction or orientation. Thus, in the left connection device of FIG. 1 they each rotate clockwise for contacting, and in the right connection device 2 of FIG. 1 they each rotate anticlockwise for contacting. For release, they are each rotated in the reverse direction. This advantageous functionality is to be explained in greater detail in the following.

Using the rotary lever arrangement 5, the clamping spring arrangement 4 can be pivoted from an open position (FIG. 1a) (via the plurality of intermediate steps of FIG. 1b to 1d, FIGS. 2a to 2e, FIGS. 3a to 3e) into a contact position (FIG. 1e, 2e, 3d). The rotary lever arrangement 5 has a cam-like shaping. The rotary lever arrangement 5 has a preferably disc-like rotary lever element 50, which is mounted rotatably in the housing 1 in or on a preferably central section 500 and has the axis of rotation D2. This can be implemented in various ways. For example, the rotary lever element 50 may be placed on or passed through by a journal in the housing 1, and/or may be inserted into a rotary receiving contour 15 of the housing—a recess—which in any case encloses it in sections on the outer periphery.

The rotary lever element 50 has an actuating section 501, which is preferably accessible from outside the housing 1, in particular at an opening 16 on the upper face 12 of the housing 1. The actuating section 501 may for example be formed as a shoulder protruding radially from the central section 500 or as an opening, in the region 500, which makes it possible to apply a tool, in particular a screwdriver or the like. Said section may also serve as a stop for delimiting the angle of rotation, in and/or counter to the direction of rotation, in cooperation with an opening 16 of the housing from which it projects (see FIG. 2a in each case).

The rotary lever element 50 further has a cam section 502. In the present case, the cam section 502 is configured as a sort of arm, which extends radially outwards, eccentrically, in the present case substantially tangentially, with respect to the central section 500.

The cam section 502 has, on the face thereof facing the clamping spring arrangement 4, a sort of control curve 503, against which the actuating limb or limbs 411, 412 of the clamping springs 41, 42 can be brought to bear.

A projection of the cam section 502 or a pin 504 or the like inserted into said section may engage in a slotted link, in particular an arc-shaped slotted link 18, of the housing 1, providing a particularly secure and uniform opening movement.

In the completely open state, the cam section 502 may be positioned on the actuating limbs 411. However, this is not a compulsory requirement (FIG. 2a). Rather, it is also conceivable for said section to be positioned somewhat spaced apart from the clamping spring arrangement 4, as shown in FIG. 1a, in the completely open position.

The clamping spring arrangement 4 may be held—for example using an ancillary spring (not shown here)—in the opening position of FIG. 2, or the conductor end 3 of said arrangement may be moved into said position when the rotary lever arrangement 5 is rotated into the opening position thereof, in which the cam section 502 is rotated upwards (away from the busbar section 6).

In the position of FIG. 1a, the rotary lever arrangement 5 thus releases the clamping spring arrangement 4, in such a way that it can be pivoted around, by a tool or the conductor, in a direction of rotation “−DR”, to the left in FIG. 2a or 3a or to the right in the right connection device in FIG. 1a. As a result, a conductor end 3 can be inserted into the corresponding connection device—on the right in FIG. 1a or on the left in FIG. 2a.

To establish the contact position, the rotary lever arrangement 5 is now rotated in a direction of rotation “DR” counter to the direction of rotation “−DR”, in such a way that the control curve 503 of the cam section 502 comes to bear against the clamping spring arrangement 4 (FIG. 2b). Upon further rotation in the direction of rotation DR (FIG. 1d, 1d, 2b,c, 3b,c), the cam section 501 acts like a rotary lever—in the present case like an increasingly long rotary lever—on the actuating limb or limbs 411, 412. In the present case, it acts on the outer actuating limb 411 and presses it downwards in the −Z-direction (in other words, in the present case, downwards in the direction of the carrier rail). As a result, the entire clamping spring arrangement 4 is rotated in a direction of rotation DR identical to the direction of rotation DR. This presses the clamping limb or limbs 410 harder and harder radially against the conductor end 3 and presses said end against the associated busbar section 6.

FIGS. 1b to 1f—right side of the series terminal shown—show here how the region at which the cam section 501 touches the clamping spring arrangement 4 in each case migrates radially further outwards on the cam section 501 from picture to picture with increasing closing or pressing of the clamping spring arrangement 4 against the conductor. In the present case, this takes place until the pin 504 in the radially outermost region of the cam section 501 is reached.

In FIG. 1, the end contact position has been reached in FIG. 1f. In this position, the actuating limbs 411, 421 and/or the rotary lever arrangement 5 can additionally be fixed in a positive and/or non-positive fit, for example on the busbar section 6 or on another element, in such a way that a particularly stable end contact position is implemented, which is not released even under relatively high stresses.

The advantages described in the above paragraphs were not recognised, or insufficiently recognised, in the prior art, since therein the focus was on other, less important points in the structural implementation. The invention deviates from this, and instead focuses on reliably achieving uniform wiring movement and unwiring movement and achieving a high contact force in the end contact position. In the following, further structural variants are described by way of which the invention can be further optimised.

Thus, the actuating limb or limbs 411, 421 may be formed elbowed at the free ends thereof so as to ensure good sliding of the control curve on the actuating limb or limbs 411, 421.

When the end contact position is reached, the clamping limb or limbs 410, 420 press on the conductor end (FIG. 1d, e), preferably until the clamping spring arrangement 4 and/or the rotary lever arrangement 5 are fixed on a thrust bearing in a positive and/or non-positive fit.

Preferably, for this purpose it is provided that a latching means, for example the aforementioned pin 504, is formed on the cam section 502, and is movable into a fixing position in the slotted link 18. Particularly preferably, this fixing position is formed in the busbar. For this purpose, it may advantageously be provided that the slotted link 18, in the housing, transitions into a corresponding slotted link 60 in the associated busbar section 6, or rather ends in said section, before the latching position is reached. In this case, the slotted link 60 may have, in the associated busbar section, a constriction point 61 or a top-dead-centre point in which the pin 504 is fixed securely in place when the end contact position is reached.

It is particularly advantageous if the end contact position is durably securely fixed on the metal busbar 6 and not in the plastics material housing 1. In this case, attaching a pin 504 to the cam section and forming the latching position in the slotted link 60 of the busbar section 6 is a particularly simple variant of a fixing of the spring arrangement in the end contact position, which also results in simple, uniform operability when establishing and releasing the contact position. It is also advantageous in particular that, for release from the end contact position, no latching hook or the like on the spring arrangement has to be released from a locking position.

In FIG. 3, it is provided that the spring carrier 45 is arranged pivotably in the housing 1. Since in the present case the actuating limb is arranged rotationally engaged on said carrier, it thus joins in with the functionality of this actuating limb 411 in whole or in part. This functionality is shown in FIG. 3. In the present case, over part of the rotational movement, the cam section 502 acts on the spring carrier 45 or on an arm 452 of the spring carrier, and additionally rotates the contact spring(s). The clamping limb or limbs are free, and they still function as clamping spring limbs. In the present case, the spring carrier 45 thus also forms part of the clamping spring arrangement 4.

FIG. 4) additionally illustrates, in an exploded view, the design of a series terminal. The disc-like design of the housing 1 in a stackable configuration can clearly be seen. In addition, it can clearly be seen here that the disc-like housing 1 may be constructed in a plurality of parts. The housing 1 may for example be composed of two half-shells 101 and 102, as shown. In one or both of the half-shells 101, 102, the slotted link 18 may be formed, which in the present case is aligned, at one end thereof, with the slotted link 60 in the associated busbar section 6 in each case. The other half-shell is formed as a rear wall in the present case.

### LIST OF REFERENCE NUMERALS

Housing 1
Connection devices 2
Conductor end 3
Clamping spring arrangement 4
Rotary lever arrangement 5
Busbar section 6
Affixing foot 11
Upper face 12
Plug-in faces 13, 14
Rotary receiving contour 15
Opening 16
Insertion opening 17
Slotted link 18
Half-shells 101, 102
Spring carrier 45
Journal section 451
Spring carrier arm 452
Leaf springs 41, 42
Clamping limbs 410, 420
Actuating limbs 411, 421
Bending region 412, 422
Rotary lever element 50
Section 500
Actuating section 501
Cam section 502
Control curve 503
Pin 504
Slotted link 60
Constriction point 61
Slot 62
Axis of rotation D1 or D1′

1. Connection device for the connection of a conductor end (3), which connection device has a housing (1) and also a busbar section (6), a clamping spring arrangement (4) and a rotary lever (5) arrangement in the housing (1), the clamping spring arrangement (4) being able to be rotated, with the aid of the rotary lever arrangement (5), from an open position to a contact position, in which contact is made with the conductor end (3), characterised in that the rotary lever arrangement (5) and the clamping spring arrangement (4) have the same direction of rotation (DR) during the rotation from the open position into the contact position.

2. Connection device according to claim 1, characterised in that the busbar section (6) is configured trough-shaped, in particular V- or U-shaped, in cross section, the conductor end (3) being insertable into the busbar section (6) perpendicular to this cross section, and in that the clamping spring arrangement (4) is designed to be pivoted, at least in sections, into the busbar section (6) transverse to the conductor insertion direction so as to press the conductor end (3) in the end contact position into the trough-shaped busbar section (6) so as to contact said section in this region.

3. Connection device according to any of the preceding claims, characterised in that the clamping spring arrangement consists of one or more clamping springs (41, 42) which are each embodied as leaf springs and each have at least one clamping limb (410, 420) and at least one actuating limb (411, 421).

4. Connection device according to any of the preceding claims, characterised in that the at least one clamping limb (410, 420) and the at least one actuating limb (411, 421) are oriented at an angle, preferably at an acute angle of between 5° and 85°, in relation to one another and are connected to one another by means of a bending region (412, 422), the bending region (412, 422) of at least one of the leaf springs bearing against a spring carrier (45).

5. Connection device according to any of the preceding claims, characterised in that the axis of rotation D1 of the clamping spring arrangement (4) and sections of the clamping spring arrangement (4) are arranged above the conductor end (3) to be contacted and above the associated busbar section (6), and in that the rotary lever arrangement (5) has an axis of rotation D2 which is positioned above the axis of rotation D1 of the clamping spring arrangement (4).

6. Connection device according to any of the preceding claims, characterised in that the rotary lever arrangement (5) has a rotary lever element (50) which is mounted rotatably in the housing (1) in or on a preferably central section (500) and which has the axis of rotation (D2) and in that the rotary lever element (50) has a cam section (502), which has a control curve (503) on which the actuating limb or limbs of the clamping springs slide along during a movement into the end contact position.

7. Connection device according to any of the preceding claims, characterised in that the cam section (502) engages in a slotted link (18) of the housing (1) by means of a projection or a pin (504) or the like inserted into said section.

8. Connection device according to any of the preceding claims, characterised in that the effective lever arm, by means of which the cam section acts on the actuating limb (411, 421) in the region of the control curve of said section, changes during the movement into the contact position.

9. Connection device according to any of the preceding claims, characterised in that, in the end contact position, the clamping spring arrangement (4) and/or the rotary lever arrangement (5) are additionally fixed in a positive and/or non-positive fit, for example on the busbar section (6) or on another element.

10. Connection device according to any of the preceding claims, characterised in that, when the end contact position is reached, the clamping limb or limbs (410, 421) press on the conductor end (39), the clamping spring arrangement (4) and/or the rotary lever arrangement (5) additionally preferably being locked on a thrust bearing in a positive and/or non-positive fit by means of a locking device.

11. Connection device according to any of the preceding claims, characterised in that the clamping and/or latching means is formed on the cam section (502), which clamping and/or latching means is movable in the slotted link (18) into a fixing position.

12. Connection device according to any of the preceding claims, characterised in that the clamping and/or latching means is the pin (504), which is movable in the slotted link (18) into a fixing position.

13. Connection device according to any of the preceding claims, characterised in that the fixing position is formed in the busbar section (6).

14. Connection device according to any of the preceding claims, characterised in that, in the housing (1), before the latching position is reached, the slotted link (18) transitions into a corresponding slotted link (60) in the associated busbar section (6), or rather ends in said section, and in that this slotted link (60) has a point, in particular a constriction point or a top-dead-centre point, at which the pin (504) is fixed securely in position when the end contact position is reached, in such a way that the end contact position is durably securely fixed at the metal busbar section (6).

15. Connection device according to any of the preceding claims, characterised in that the rotary lever element (50) has an actuating section (501).

16. Connection device according to any of the preceding claims, characterised in that the spring carrier (45) is formed in a single piece with the housing (1).

17. Connection device according to any of the preceding claims, characterised in that the spring carrier (45) is formed as a part which is separate from the housing (1) and in that the clamping spring arrangement (4) is capable of being preassembled on the spring carrier (45) and in that the preassembled unit is preferably insertable into the housing (1) separately and is able to be affixed there individually or together with the associated busbar section (6), for example in a positive and/or non-positive fit, in particular by clamping and/or latching.

18. Connection device according to any of the preceding claims, characterised in that the spring carrier (45) is arranged pivotably in the housing.

19. Connection device according to any of the preceding claims, characterised in that the cam section (502) acts on the spring carrier (45) and rotates it together with the clamping spring arrangement (4).

20. Connection device according to any of the preceding claims, characterised in that the clamping springs (41, 42) are arranged laid inside one another in such a way that the bending regions (412, 422) thereof are positioned inside one another and have exactly or substantially the same axis of rotation D1 or D1′.

21. Connection device according to any of the preceding claims, characterised in that the actuating limbs (411, 421) and/or the clamping limbs (410, 420) of the leaf springs (41, 42) are of different lengths.

22. Connection device according to any of the preceding claims, characterised in that the spring carrier (45) has a rounded journal section (451), about which the clamping springs (41, 42) can be rotated in the bending regions (411, 412) thereof.

23. Connection device according to any of the preceding claims, characterised in that the actuating limb or limbs (411, 421) are formed elbowed at the free ends thereof so as to slide on the control curve (503).

24. Connection device according to any of the preceding claims, characterised in that it has a restoring spring (43).
